(19) United States
(12) Patent Application Publication
(10) Pub. No.: US 2022/0114499 A1
(43) Pub. Date: Apr. 14, 2022

(54) SYSTEM AND METHOD FOR EFFICIENTLY TRAINING INTELLIGIBLE MODELS

(71) Applicant: ALIPAY (HANGZHOU) INFORMATION TECHNOLOGY CO., LTD., Hangzhou (CN)

(72) Inventors: Yin LOU, Sunnyvale, CA (US); Yongliang WANG, HANGZHOU (CN); Shiwei LIANG, HANGZHOU (CN); Yang DONG, HANGZHOU (CN)

(21) Appl. No.: 17/487,901

(22) Filed: Sep. 28, 2021

Related U.S. Application Data
(63) Continuation of application No. PCT/CN2020/120683, filed on Oct. 13, 2020.

(51) Int. Cl. G06N 20/20; G06N 5/04

(52) U.S. Cl. CPC G06N 20/20; G06N 5/04

(57) ABSTRACT

Methods, systems, and apparatus, including computer programs encoded on computer storage media, for training explainable machine learning models are described. An exemplary method includes obtaining, by sampling without replacement for a plurality of times, a plurality of training datasets from a plurality of historical data records, including a first training dataset and a second training dataset with one or more overlapped historical data records; generating a plurality of histograms respectively corresponding to the plurality of training datasets, in which a histogram of the second training dataset reuses one or more data points corresponding to the one or more overlapped historical data records in a histogram of the first training dataset; training, based on the plurality of histograms, one or more machine learning models corresponding to the one or more user features; and providing personalization based on the one or more machine learning models.

### CROSS-REFERENCE TO RELATED APPLICATIONS

This application is a continuation application of International Patent Application No. PCT/CN2020/120683, entitled “SYSTEM AND METHOD FOR EFFICIENTLY TRAINING INTELLIGIBLE MODELS,” filed on Oct. 13, 2020. The entire content of the above referenced application is incorporated herein by reference.

### TECHNICAL FIELD

This application generally relates to systems and methods for improving efficiency for training machine learning models and, in particular, to systems and methods for efficiently training intelligible models for global explanations.

### BACKGROUND

Personalization, or broadly known as customization, involves tailoring a service or a product to accommodate specific individuals, sometimes tied to groups or segments of individuals, which may significantly improve customer satisfaction, sales conversion, marketing results, advertising, branding, and various website or application metrics.

Personalization is widely adopted in social media and recommender systems. The implementation of personalization may be through learning the user data, exploring underlying relationships between user features and user reactions, and constructing regression and/or classification intelligible models (e.g., machine learning models) based on the underlying relationships. The machine learning models may predict user's behavior based on various user features, and thus enable personalized services and products for individual users.

Generalization Additive Models (GAMs) are one of the popular methods for building intelligible models on classification and regression problems. Fitting the most accurate GAMS is usually done via gradient boosting with bagged shallow trees. However, such method cycles one-at-a-time through all the records in the training samples and thus is usually expensive and impractical for large industrial applications. The present application describes an accurate and more efficient way to improve the training efficiency of GAMs and thus the personalization process.

### SUMMARY

Various embodiments of the specification include, but are not limited to, systems, methods, and non-transitory computer-readable media for efficiently training explainable machine learning models.

According to some embodiments, a computer-implemented method for efficiently training explainable machine learning models may include: obtaining, by sampling without replacement for a plurality of times, a plurality of training datasets from a plurality of historical data records, each of the plurality of historical data records comprising one or more user features and a user response, where the plurality of training datasets include a first training dataset and a second training dataset with one or more overlapped historical data records; generating a plurality of histograms respectively corresponding to the plurality of training datasets, where a histogram of the second training dataset reuses one or more data points corresponding to the one or more overlapped historical data records in a histogram of the first training dataset; training, based on the plurality of histograms, one or more machine learning models corresponding to the one or more user features, where each of the one or more machine learning models learns a relationship between a corresponding user feature and the plurality of user responses; and providing personalization based on the one or more machine learning models.

In some embodiments, the method may further include ensembling the one or more machine learning models into a generalized linear model for predicting user responses based on the one or more user features; and wherein the providing personalization based on the one or more machine learning models includes: providing personalization based on the generalized linear model.

In some embodiments, the obtaining the plurality of training datasets from the plurality of historical data records by sampling without replacement for a plurality of times includes: randomly arranging the plurality of historical data records; sampling the first training dataset without replacement from the plurality of randomly arranged historical data records; randomly rearranging the plurality of historical data records; and sampling the second training dataset without replacement from the plurality of randomly rearranged historical data records.

In some embodiments, the first training dataset and the second training dataset are equal in size and each includes more than half of the plurality of historical data records.

In some embodiments, the generating a plurality of histograms respectively corresponding to the plurality of training datasets includes: generating a first histogram based on the first training dataset; identifying one or more first historical data records that are in the first training dataset but not in the second training dataset, and one or more second historical data records that are in the second training dataset but not in the first training dataset; and generating a second histogram based on the first histogram by removing one or more data points corresponding to the one or more first historical data records and adding one or more data points corresponding to the one or more second historical data records.

In some embodiments, the training one or more machine learning models corresponding to one or more user features based on the plurality of histograms includes: for each of the one or more user features, constructing a plurality of single-feature shallow trees based on the plurality of histograms; and aggregating the plurality of single-feature shallow trees into a single-feature machine learning model corresponding to the user feature.

In some embodiments, the one or more machine learning models include one or more regression models or one or more classification models.

In some embodiments, the method may further include ordering the plurality of training datasets for minimizing a computational cost for generating the plurality of histograms.

In some embodiments, the ordering the plurality of training datasets includes: constructing a fully connected graph comprising a plurality of nodes corresponding to the plurality of training datasets and a plurality of edges, wherein each of the plurality of edges connects two training datasets and is associated with a weight related to a number of historical data records belonging to either of the two training datasets, but not in their intersection; determining a minimum spanning tree of the fully connected graph, wherein the minimum spanning tree includes a subset of the plurality of edges connecting the plurality of nodes with a minimum total edge weight; and ordering the plurality of training datasets based on the minimum spanning tree.

In some embodiments, the ordering the plurality of training datasets based on the minimum spanning tree includes: selecting a node from the minimum spanning tree as a starting point; performing a breadth-first search (BFS) to determine a processing sequence of the plurality of nodes in the minimum spanning tree; and ordering the plurality of training datasets based on the processing sequence of the plurality of nodes in the minimum spanning tree.

In some embodiments, the personalization includes personalized product or service configurations.

In some embodiments, the personalization includes individual-level predictions based on the one or more features of an individual.

According to other embodiments, a system for efficiently training explainable machine learning models includes one or more processors and one or more computer-readable memories coupled to the one or more processors and having instructions stored thereon that are executable by the one or more processors to perform operations comprising: obtaining, by sampling without replacement for a plurality of times, a plurality of training datasets from a plurality of historical data records, each of the plurality of historical data records comprising one or more user features and a user response, where the plurality of training datasets include a first training dataset and a second training dataset with one or more overlapped historical data records; generating a plurality of histograms respectively corresponding to the plurality of training datasets, where a histogram of the second training dataset reuses one or more data points corresponding to the one or more overlapped historical data records in a histogram of the first training dataset; training, based on the plurality of histograms, one or more machine learning models corresponding to the one or more user features, where each of the one or more machine learning models learns a relationship between a corresponding user feature and the plurality of user responses; and providing personalization based on the one or more machine learning models.

According to yet other embodiments, a non-transitory computer-readable storage medium for efficiently training explainable machine learning models is configured with instructions executable by one or more processors to cause the one or more processors to perform operations comprising: obtaining, by sampling without replacement for a plurality of times, a plurality of training datasets from a plurality of historical data records, each of the plurality of historical data records comprising one or more user features and a user response, where the plurality of training datasets include a first training dataset and a second training dataset with one or more overlapped historical data records; generating a plurality of histograms respectively corresponding to the plurality of training datasets, where a histogram of the second training dataset reuses one or more data points corresponding to the one or more overlapped historical data records in a histogram of the first training dataset; training, based on the plurality of histograms, one or more machine learning models corresponding to the one or more user features, where each of the one or more machine learning models learns a relationship between a corresponding user feature and the plurality of user responses; and providing personalization based on the one or more machine learning models.

Embodiments disclosed herein have one or more technical effects. In some embodiments, the training of a GAM relies on subsample aggregating (also called subagging or sub-bagging) instead of bootstrap aggregating (bagging) to construct the training datasets for training trees in the GAM. The subsample aggregating refers to sampling without replacement, and the bootstrap aggregating refers to sampling with replacement. Using subsample aggregating for training GAMs provides opportunities for performance improvement. For example, a plurality of training datasets may be sampled from a training data superset, which may contain (or after simple filtering) a plurality of unique data samples. The training datasets obtained through subsample aggregating from the training data superset will similarly include unique data samples. In contrast, training datasets obtained through bootstrap aggregating from the training data superset may have duplicated data samples. This “uniqueness” in the training datasets obtained through subsample aggregating may be further exploited to reduce repetitive computations during the training of GAMs. For example, in order to train a GAM, a plurality of shallow decision trees (e.g., weak learners) need to be constructed. The construction of such shallow decision trees may be based on histograms generated from the training datasets. In traditional solutions with bootstrap aggregating, the histograms are generated by processing one-at-a-time through all data samples in each of the training datasets, which is computationally expensive and impractical for industry-scale application. In contrast, by using subsample aggregating, two training datasets of a reasonable size (e.g., 60% of the entire training superset) usually have overlapped data samples, and within each of the training datasets, these data samples are also unique. These overlapped but unique data samples may allow the histogram constructions to be accelerated by avoiding the one-at-a-time processing manner. That is, constructing a histogram may skip processing these data samples if they have been previously processed for constructing another histogram. Hence, there is no duplicate computational cost for the overlapped data samples, and the efficiency for generating the histograms (and thus the training of shallow trees and the GAM) may be significantly improved. In some embodiments, in order to fully exploit the potential to save the computational cost, the present application describes ways to carefully order the training datasets, so that the consecutive training datasets share as many data samples as possible. By doing so, the overall computational cost-saving for constructing histograms is maximized. Furthermore, some embodiments disclosed herein describe real-life applications of the efficient training of GAMs for personalization/customization, which demonstrate that the described methods are efficient, accurate, and practical.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as limiting.

### BRIEF DESCRIPTION OF THE DRAWINGS

FIG. 1 illustrates an environment associated with personalization with Generalization Additive Models (GAMs) in accordance with some embodiments.

FIG. 2 illustrates a diagram of an exemplary method for efficient training of GAMs in accordance with some embodiments.

FIG. 3 illustrates exemplary methods for training GAMs in accordance with some embodiments.

FIG. 4 illustrates a diagram of an exemplary method for efficiently constructing histograms in accordance with some embodiments.

FIG. 5 illustrates a diagram of an exemplary method for training GAMs with improved efficiency in accordance with some embodiments.

FIG. 6 illustrates an exemplary application of efficient training of GAMs in accordance with some embodiments.

FIG. 7 illustrates an exemplary method for efficiently training GAMs in accordance with some embodiments.

FIG. 8 illustrates a block diagram of a computer system for efficiently training and applying explainable machine learning models in accordance with some embodiments.

FIG. 9 illustrates a block diagram of a computer system in which any of the embodiments described herein may be implemented.

### DETAILED DESCRIPTION

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope, and contemplation of the present invention as further defined in the appended claims.

Personalization, customization, or individual-level predictions require understanding the underlying relationships between user features and user actions or reactions. The term “users” here refers to a general concept of objects that interact with a system. These objects may include individual users, user accounts, user requests, entities, or users in other suitable forms that are associated with a plurality of user features. The system may refer to an e-commerce platform (e.g., goods or service providing platforms), a risk-evaluation platform/system, a ride-sharing or ride-hailing platform, or another suitable system that interacts with the plurality of users or objects. The tasks to learn and approximate these underlying relationships may be formed as classification and regression problems. These problems may be tackled by training various intelligible machine learning models based on the features of individuals and their responses or actions. Exemplary models include Generalized Additive Models (GAMs) or other suitable generalized linear models that are explainable. In the present application, a GAM is used as an example to describe a novel and efficient training process that may be applicable to various intelligible machine learning models.

For an easy understanding of embodiments covering the efficient training process, it may be beneficial to first explain how GAM works. Typically, GAM may be written as formula (1):

$$g ( E [ y ] ) = {β}_{o} + {\sum }_{j} {f}_{j} ( {x}_{j} ) \qquad ( 1 )$$

where g refers to a link function and fⱼ refers to a shape function, y refers to user response or action, E(y) refers to the expectation value of y, and βₒ refers to an intercept. For identifiability, fⱼ's are usually centered, i.e., E(fⱼ)=0. Since GAM only has univariate components, it is easy to visualize those on-dimensional additive components. That is, it is a completely white-box model and provides global additive explanations. GAMs have been demonstrated to be useful and accurate in many mission-critical applications, such as healthcare and bias detection in recidivism prediction.

The training (also called fitting) algorithms for GAMs usually employ a combination of bootstrap aggregating (also called bagging) and gradient boosting as the optimization method. For example, GAMs may run gradient boosting with bagged shallow trees that cycles one-at-a-time through the training data samples, which has been proven expensive and inefficient, especially for industry-scale applications. To solve this problem, the embodiments described in the present application demonstrate an improved training process for GAMs and other suitable models involving training and ensembling multiple weak learners (e.g., shallow decision trees).

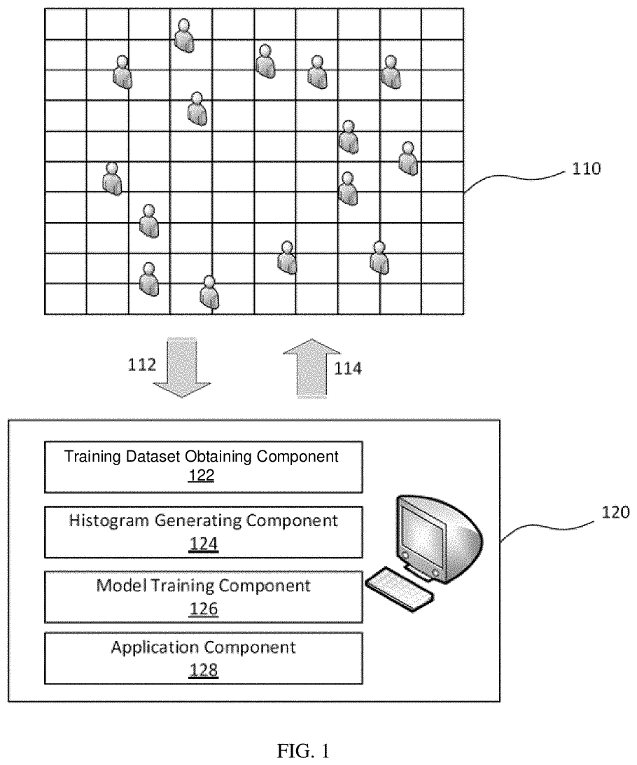

FIG. 1 illustrates an environment associated with efficiently training Generalization Additive Models (GAMs) for personalizing services and products in accordance with some embodiments. The environment may include a computing system 120 and a user pool 110 interacting with the computing system 120. The computing system 120 may be implemented in one or more networks (e.g., enterprise networks), one or more endpoints, one or more servers (e.g., server), or one or more clouds. The server may include hardware or software which manages access to a centralized resource or service in a network. A cloud may include a cluster of servers and other devices that are distributed across a network. The computing device 120 may also be implemented on or as various devices such as a mobile phone, tablet, server, desktop computer, laptop computer, etc. The communication between the user pool 110 and the computing device 120 may be over the internet, through a local network (e.g., LAN), or through direct communication (e.g., BLUETOOTH™, radio frequency, infrared).

In some embodiments, the computing system 120 may refer to a platform providing services or products to users in the user pool 110 through channel 114 such as webpages, mobile applications, or another suitable communication channel. The users' responses or actions in response to the services or products may then be collected through channel 112 (e.g., through the websites and/or the mobile applications) and stored as historical data records for the platform to learn the user behavior and further improve the quality of its services and products.

In some embodiments, the computing system 120 may include a training dataset obtaining component 122, a histogram generating component 124, a model training component 126, and an application component 128. Depending on the implementation, the computing system 120 may have fewer, more, or alternative components.

In some embodiments, the training datasets obtaining component 122 is configured to obtain, by sampling without replacement for a plurality of times, a plurality of training datasets from a plurality of historical data records each comprising one or more user features and user response. In the following description, a “training dataset” may be referred to as a sample, and each historical data record in the training dataset may be referred to as a historical data record. The “sampling without replacement” here refers to subsample aggregating (subagging), in which each of the plurality of historical data record has only one chance to be selected into the same training dataset. This is different from the bootstrap aggregating (sampling with replacement, or bagging that is used in existing solutions) in which each historical data record may be selected multiple times into the same training dataset. This difference is critical for improving the training efficiency of GAMs for at least the following reason: training a GAM involves training a plurality of weak learners (e.g., shallow decision trees), which are constructed based on histograms generated from the training datasets. When two training datasets have overlaps, i.e., share one or more unique historical data records, the generation of the histograms for the two training datasets may reuse the computational results of the shared records, thus avoiding the cost of duplicated computations. Without this “uniqueness” attribute (e.g., using bootstrap aggregating), one historical data record may exist in a first training dataset for X times while in a second training dataset for Y times (X and Y are different), thus the computational result of the historical data record may have different weights in the histogram of the first training dataset and the histogram of the second training dataset, and accordingly, the computational result may not be directly reused and the computational cost cannot be saved.

In some embodiments, the subagging process may be described as: randomly arranging the plurality of historical data records; sampling a first training dataset without replacement from the plurality of randomly arranged historical data records; randomly rearranging the plurality of historical data records; and sampling a second training dataset without replacement from the plurality of randomly rearranged historical data records. In some embodiments, a percentage of the plurality of historical data records may be selected to form each training dataset. For example, after the plurality of historical data records is randomly arranged, 60% of the historical data records are selected to form the first training dataset; and after randomly rearranging the plurality of historical data records again, 60% of the rearranged historical data records may be selected to form the second training dataset. In some embodiments, the plurality of training datasets sampled without replacement from the plurality of historical data records comprise a first training dataset and a second training dataset with one or more overlapped historical data records. Using the same example as above, selecting 60% of the historical data records into each training dataset will result in overlaps among the training datasets.

In some embodiments, the histogram generating component 124 is configured to generate a plurality of histograms respectively corresponding to the plurality of training datasets. When a first training dataset and a second training dataset have one or more overlapped historical data records, the generation of a histogram for the second training dataset may reuse one or more data points corresponding to the one or more overlapped historical data records in a histogram of the first training dataset. In some embodiments, the histogram generation process may be described as: generating the first histogram based on the first training dataset; identifying one or more first historical data records that are in the first training dataset but not in the second training dataset, and one or more second historical data records that are in the second training dataset but not in the first training dataset; and generating a second histogram based on the first histogram by removing one or more data points corresponding to the one or more first historical data records and adding one or more data points corresponding to the one or more second historical data records. That is, generating a histogram based on another histogram involves computing data points for the data records belonging to either of the two training datasets, but not in their intersection.

As explained above, the generation of a histogram may reuse the computational results from another previously generated histogram in order to reduce cost and improve efficiency. It means the order in which the histograms are generated will affect the overall computational cost. In some embodiments, the training datasets may be carefully ordered so that the total cost of generating the corresponding histograms is minimized. For example, the ordering may be implemented by: constructing a fully connected graph comprising a plurality of nodes corresponding to the plurality of training datasets, and a plurality of edges each of which connects two training datasets and is associated with a weight related to a number of historical data records belonging to either of the two training datasets, but not in their intersection; determining a minimum spanning tree of the fully connected graph, where the minimum spanning tree comprises a subset of the plurality of edges connecting the plurality of nodes with a minimum total edge weight; and ordering the plurality of training datasets based on the minimum spanning tree.

In some embodiments, the model training component 126 may be configured to train one or more machine learning models corresponding to the one or more user features based on the plurality of histograms. Each of the one or more machine learning models learns a relationship between a corresponding user feature and the plurality of user responses. In some embodiments, each machine learning model may be constructed by: for each of the one or more user features, constructing a plurality of single-feature shallow trees based on the plurality of histograms; and aggregating the plurality of single-feature shallow trees into a single-feature machine learning model corresponding to the user feature. In some embodiments, these single-feature machine learning models may be ensembled into a generalized linear model (e.g., by linearly aggregating the single-feature machine learning models). For example, as described previously, a GAM (or a generalized linear model) may be constructed by a plurality of shape functions (single-feature machine learning models) as shown in formula (1).

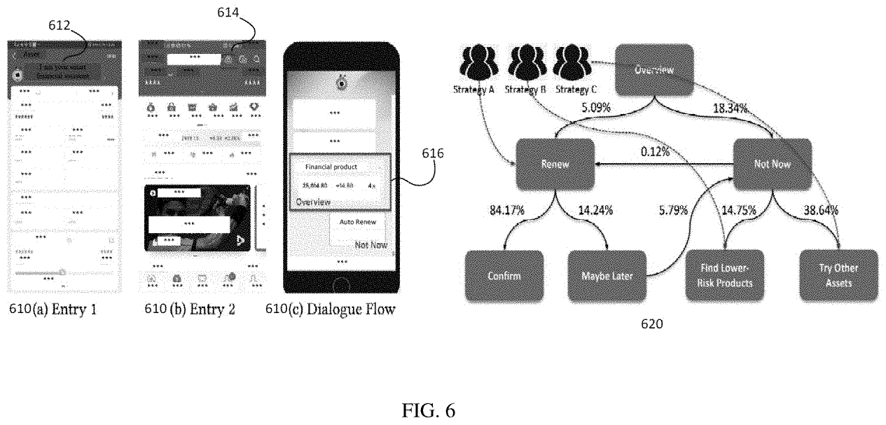

In some embodiments, the application component 128 may be configured to deploy the plurality of single machine learning models (e.g., in a form of an ensembled generalized linear model for regression or classification) into practical applications. One exemplary application may be personalization or customization to tailor a service or a product based on individual user's various features. For example, a UI design may be personalized targeting different users, personalized recommendations may be made based on individual user's features and/or history, more accurate predictions may be generated based on individual-level features, etc. In FIG. 6, a real-life application of a trained GAM is described in detail.

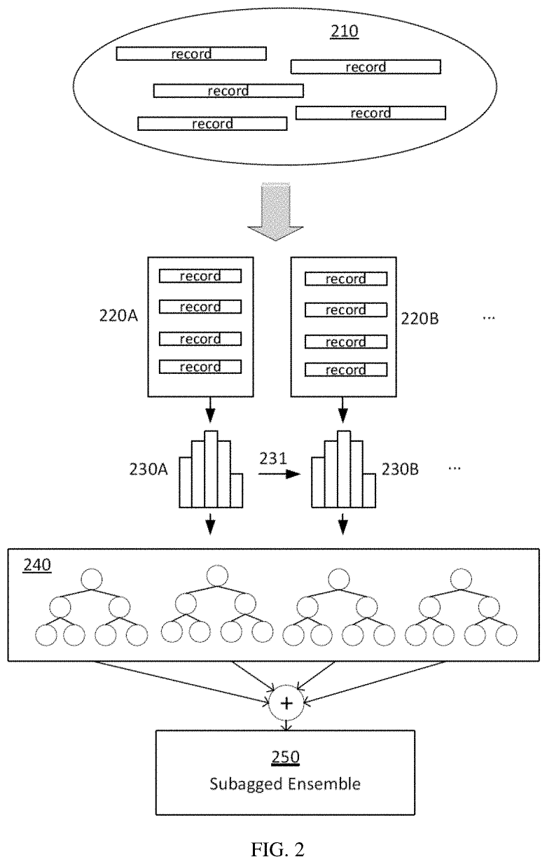

FIG. 2 illustrates a diagram of an exemplary method for efficient training of GAMs in accordance with some embodiments. The training process may start with obtaining training data 210. Taking an e-commerce platform as an example, the training data 210 for training GAM to understand user behaviors may include historical interactions between the platform and users. Each of the interactions may include a product or service (e.g., with specific configurations) provided to a user and the user's response. These historical interactions may be collected by the platform and stored as historical data records. For simplicity, in the following descriptions, let D={(xᵢ, yᵢ)}ᵢ₌₁^{N} denote the plurality of historical data records of size N, where i is the index of iₜₕ data records, xᵢ=(xᵢ₁, . . . , xᵢₚ) refers to a feature vector with p features (e.g., the features of the user associated with the iₜₕ data record), and yᵢ may refer to the user response; and let x=(x₁, . . . , xₚ) denote the p user features. Additionally, it is assumed that each data point may have a weight wᵢ.

In some embodiments, a plurality of training datasets 220A and 220B may be sampled from the collected training data 210. By sampling without replacement (subagging) from the collected training data 210, each of the training datasets 220A and 220B may include unique data records therein. In some embodiments, the number of training data 210 may be finite, and the number of data records in each of the training datasets 220A and 220B may be more than half of the training data. Thus the training datasets 220A and 220B may have one or more overlapped data records.

In some embodiments, after the plurality of training datasets 220A and 220B are sampled, a plurality of histograms 230A and 230B may be generated respectively based on the plurality of training datasets 220A and 220B. A histogram is an approximate representation of the distribution of numerical data, which usually “bin” (or “bucket”) the range of values (e.g., dividing the entire range of values into a series of intervals) and then count how many values fall into each interval. Here, the “value” may refer to an attribute associated with each of the historical data records in the training datasets and may have different practical meanings depending on the actual application. In some embodiments, the generation of a histogram based on a training dataset may involve generating data points for the data records in the training dataset. For example, generating a data point for a data record may involve scanning the training data 210 for the data record.

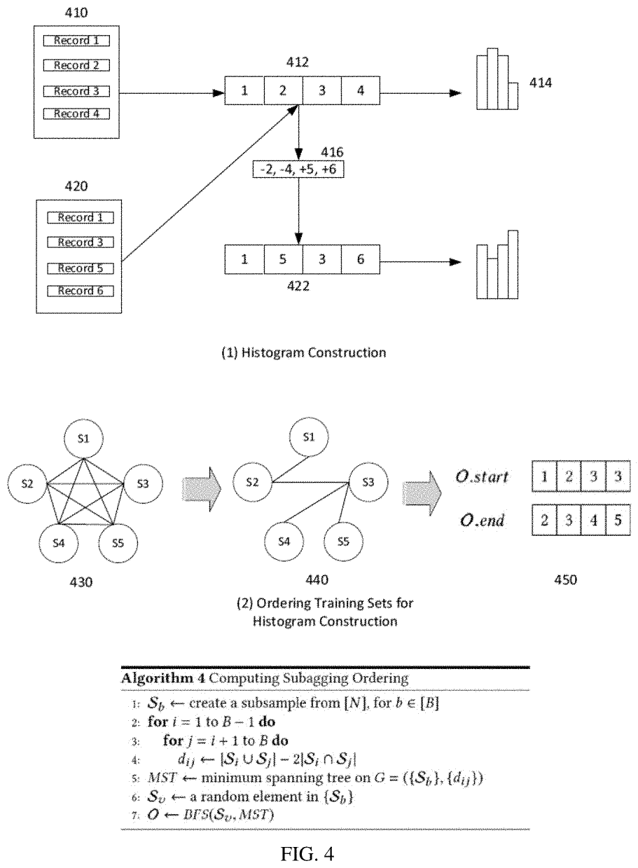

In some embodiments, the plurality of histograms 230A and 230B may be generated sequentially and reuse some of the previous data points to reduce the overall computational cost. For example, if the training datasets 220A and 220B have one or more overlapped data records, after the first histogram for the training dataset 220A is generated, the generation of the second histogram for the training dataset 220B may be accelerated by reusing the data points (step 231) corresponding to the one or more overlapped data records. By doing so, the cost of repeatedly scanning these overlapped data records may be avoided, and the entire training efficiency may be improved. Furthermore, since histogram generation is sequential, the order in which these histograms 230A and 230B are generated may directly affect how much the training efficiency improvement will be. In some embodiments, the plurality of training datasets may be sorted and arranged in a way to maximize the overlaps between adjacent training datasets 220A and 220B. A detailed description of how to sort and arrange the training datasets may be found in FIG. 4.

In some embodiments, a plurality of weak machine learning models 240 may be trained based on the plurality of histograms 230A and 230B. Here, the “weak” machine learning models 240 may refer to single-feature decision trees, each of which focuses on one single user feature. For example, such a single-feature decision tree focuses on learning the underlying relationship between the user feature and the user responses (or the impact of the single feature). In some embodiments, for one user feature in the p user features x=(x₁, . . . , xₚ), one or more single-feature shallow tree may be constructed out of each of the plurality of histograms 230A and 230B, and the resultant plurality of single-feature shallow trees may be aggregated into the single-feature decision tree corresponding to the user feature.

In some embodiments, the plurality of weak machine learning models 240 may be ensembled into a generalized linear model for predicting user responses based on the one or more user features. Since the training datasets during this process are sampled with subagging, the generalized linear model may be referred to a subagged ensemble 250 in the following description. This subagged ensemble may be deployed for regression applications or classification applications. For example, since the subagged ensemble may predict a user's response based on the user's features, service or product configuration may be personalized accordingly to improve user satisfaction or suitable key performance indicators (KPIs).

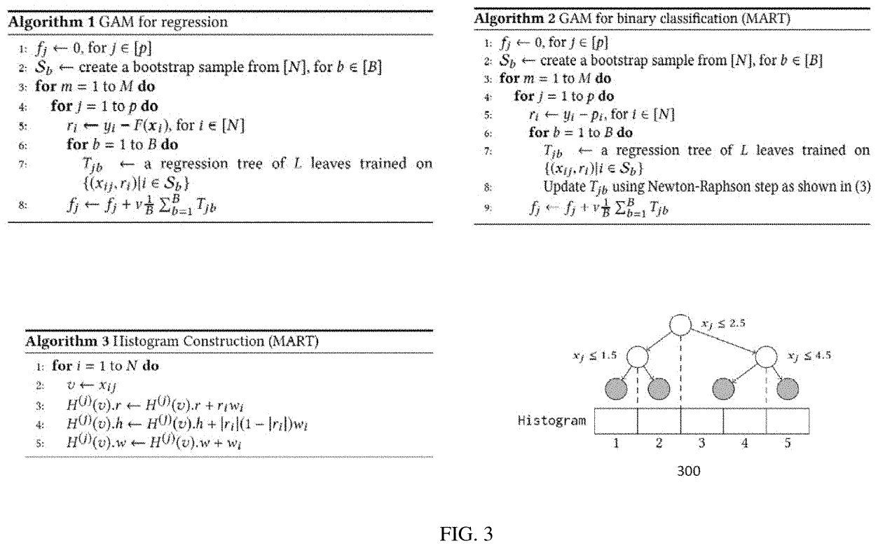

FIG. 3 illustrates exemplary methods for training GAMs in accordance with some embodiments. The illustrated methods in FIG. 3 include training GAM with cyclic gradient boosting and bootstrap aggregating (bagging), which are used in existing training mechanisms. The purpose of explaining the existing mechanisms is to better understand the improved method with subsample aggregating (subagging). The cyclic gradient boosting and bootstrap aggregating follows a variant of multiple additive regression trees (MART) algorithm that aims to find a function F=Σⱼfⱼ, where F is an ensemble and fⱼ is a shape function (e.g., a single-feature shallow tree), to minimize an objective function shown in formula (2):

$$L ( y , F ( x ) ) \qquad ( 2 )$$

where y is observation (e.g., user response), and L(.,.) is a non-negative convex loss function. A squared loss L may be used for regression problems, and a logistic loss L may be used for binary classification problems.

In FIG. 3, algorithm 1 and algorithm 2 summarize the optimization procedure for regression and classification problems, respectively. Both algorithms start with initializing the shape functions fⱼ for each of the p user features, followed by creating training datasets S_{b} of size B. During each boosting pass, all p user features are cycled through to construct (pseudo) residual rᵢ's with regarding to feature j, negative gradients in functional space. For regression problems, the residual rᵢ is equivalent to yᵢ−F(Xᵢ). For classification problems, the residual rᵢ is equivalent to yᵢ−pᵢ, where pᵢ=(1/(1+exp(−F(xᵢ)). Then both algorithms proceed to run bootstrap aggregating (bagging) and fit trees on each training dataset S_{b} (lines 6-7). For classification problems. An extra Newton-Raphson step may be added to update predictions for the leaves of the regression tree (line 8). The last step of both algorithms involves applying a learning rate v to the bagged ensemble and updating the shape function fⱼ.

For practical implementation, the regression tree in the above algorithms may refer to single-feature regression trees. Building such a single-feature regression tree is equivalent to cutting on a line. The essential statistics of line cutting are histograms. Algorithm 3 in FIG. 3 summarizes the construction of a histogram for the MART algorithm. Let H^{(j)}(v)·r and H^{(j)}(v)·w denote the weighted sum of user responses (first-order information) and weights when xⱼ=v, respectively, where v=xᵢⱼ refers to the jₜₕ feature in the iₜₕ feature vector. To facilitate the Newton-Raphson step in Algorithm 2, let H^{(j)}(v)·h to denote the weighted sum of |rᵢ|(1−|rᵢ|) for xⱼ=v (second-order information). The line cutting is more efficient than the standard regression tree because the histograms only need to be constructed once, as opposed to re-constructing histograms each time after a split in the standard regression tree.

The diagram 300 in FIG. 3 illustrates an exemplary line cutting on a histogram of size 5. The outcome of the line cutting may be a single-feature shallow tree as shown. The exemplary user feature is denoted as xⱼ, and the single-feature shallow tree constructed based on the histogram of size 5 includes three internal nodes and four leaf nodes. Each of the internal nodes refers to a test on the user feature xⱼ. For example, if xⱼ is less than 2.5, the tree goes to the left branch, and if xⱼ is greater than 1.5, the result (e.g., a class label) refers to the second data point in the histogram.

FIG. 4 illustrates a diagram of an exemplary method for efficiently constructing histograms in accordance with some embodiments. As described above, the histograms are constructed based on training datasets sampled without replacement (subagging) from a plurality of historical data records. By using sampling without replacement, each of the training datasets includes unique historical data records, and some of the training datasets may have overlapped historical data records. During the process of constructing the histograms, the computational cost associated with the overlapped historical data records is limited to one-time scanning. That is, for the overlapped historical data records in a first and a second training datasets, the data points generated for the overlapped historical data records during the construction of a first histogram for the first training dataset may be reused in the construction of a second histogram for the second training dataset.

As shown in FIG. 4 section “(1) Histogram Construction”, a first training dataset 410 includes the following historical data records: record 1, record 2, record 3, and record 4; and a second training dataset 420 includes the following historical data records: record 1, record 3, record 5, and record 6. When constructing a first histogram 412 based on the first training dataset 410, the training data superset (e.g., all historical data records) may be scanned once for each of the historical data records to generate the corresponding data points. For simplicity, the data points for the historical data records in the first training dataset 410 are labeled as 1, 2, 3, and 4. After the first histogram 412 is constructed, a corresponding single-feature shallow tree 414 may be trained based on the first histogram 412.

When constructing a second histogram 422 corresponding to the second training dataset 420, scanning the training data superset for each of the historical data records in the second training dataset 420 becomes unnecessary. In some embodiments, the construction of the second histogram 422 may include identifying one or more first historical data records that are in the first training dataset 410 and not in the second training dataset 420, and one or more second historical data records that are in the second training dataset 420 and not in the first training dataset 410; and generating the second histogram 422 by removing one or more data points corresponding to the one or more first historical data records and adding one or more data points corresponding to the one or more second historical data records. The data points corresponding to the overlapped historical data records may be directly reused. In some embodiments, removing the data points corresponding to the first historical data records also does not require expensive scanning of the training data superset. As a result, the cost of constructing the second histogram 422 merely includes scanning the training data superset for each of the historical data records that are in the second training dataset 420 but not in the first training dataset 410. As shown in FIG. 4, the operations required from the first histogram 412 to the second histogram 422 are listed in block 416, including −2, −4, +5 +6. These operations indicate that, to construct the second histogram 422, the data points 2 and 4 in the first histogram 412 need to be removed, new data points 5 and 6 need to be scanned, and all other data points in the first histogram 412 may be directly reused in the second histogram 422.

Since the efficiency improvement is a result of saving the computational cost for the overlapped historical data records between adjacent training datasets, the order in which the training datasets are processed (e.g., generating corresponding histograms) may directly affect how much the improvement is. In some embodiments, in order to maximize efficiency improvement, the training datasets may be sorted and arranged in a way to minimize the computational cost for generating the plurality of histograms. One exemplary method may include: constructing a fully connected graph comprising a plurality of nodes corresponding to the plurality of training datasets and a plurality of edges, wherein each of the plurality of edges connects two training datasets and is associated with a weight related to a number of historical data records belonging to either of the two training datasets, but not in their intersection; determining a minimum spanning tree of the fully connected graph, wherein the minimum spanning tree comprises a subset of the plurality of edges connecting the plurality of nodes with a minimum total edge weight; and ordering the plurality of training datasets based on the minimum spanning tree.

In FIG. 4 section “(2) ordering training datasets for histogram construction,” five training datasets S1˜S5 are shown for illustrative purposes. In order to minimize the total cost of constructing the five corresponding histograms, a fully connected tree 430 covering the five training datasets may be first constructed. The fully connected tree 430 includes an edge between every two training datasets. Each edge is associated with a weight representing the cost of transforming from one training dataset to another training dataset. With this fully connected tree 430, the cost minimization problem may be equivalent to finding a minimum spanning tree 440 within the fully connected tree 430. This step may be implemented with various algorithms. Once the minimum spanning tree 440 is computed, the training datasets may be sorted and arranged accordingly, and thus the histograms may be constructed in the same order. In some embodiments, a node from the minimum spanning tree 440 may be selected as the starting point and a breadth-first search (BFS) may be performed to generate the ordering. As shown in FIG. 4, the ordering 450 is represented as a data structure with two fields: O.start and O.end, which denote the vectors for starting training dataset and target training dataset, respectively.

An exemplary algorithm 4 is shown in FIG. 4 to summarize the overall flow for computing subagging ordering. For example, for two training datasets Sᵢ and Sⱼ, denoting the histogram on Sᵢ as Hᵢ, and the histogram on Sⱼ as Hⱼ, the cost of transferring Hᵢ to Hⱼ may be represented as |Sᵢ ∪Sⱼ|−2|Sᵢ ∩Sⱼ|, where ∪ stands for a union operator and ∩ stands for an intersection operator. The cost may be further decomposed into two parts: Δᵢⱼ⁺=Sⱼ−Sᵢ (the data points to add to Hᵢ), and Δᵢⱼ⁻=Sᵢ−Sⱼ (the data points to remove from Hᵢ). Line 5 of algorithm 4 refers to the step of constructing a minimum spanning tree, line 6 refers to the step of randomly picking a training dataset as the starting point (for generating histograms), and line 7 refers to the step of BFS for determining the subagging ordering.

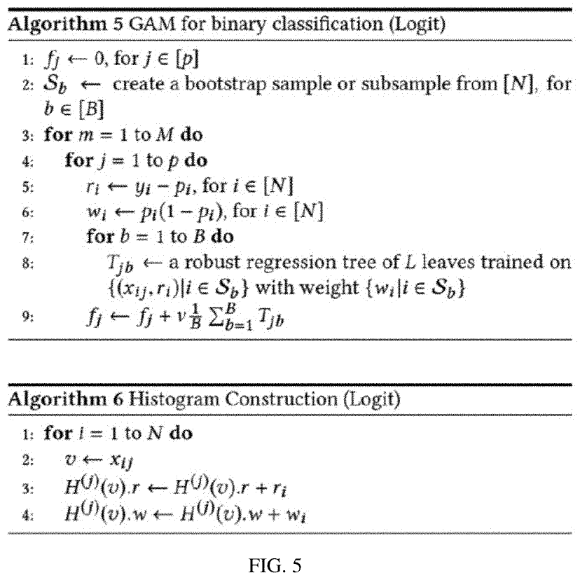

FIG. 5 illustrates a diagram of an exemplary method for training GAMs with improved efficiency in accordance with some embodiments. For classification problems, LogitBoost may lead to more accurate models than MART. The main difference is that MART uses first-order information to grow trees and second-order information to compute leaf values, whereas LogitBoost uses second-order information to do both. For this reason, some embodiments use LogitBoost with the above-described efficient training method for GAM fitting on classification problems to further improve the efficiency. An example is illustrated as algorithms 5 and 6 in FIG. 5, where Algorithm 5 summarizes GAM training for binary classification with LogitBoost, and Algorithm 6 summarizes the corresponding steps for constructing histograms.

The main difference between Algorithm 5 and Algorithm 2 is that (1) a robust regression tree is trained, and (2) the step of the Newton-Raphson step in Algorithm 2 is avoided. Robust regression tree is a numerically stable implementation in LogitBoost. In some embodiments, a robust line cutting procedure may be used for better efficiency. Similar to Algorithms 1 and 2, histograms are still the key statistics that are necessary for building the regression model.

Algorithm 6 in FIG. 5 describes an exemplary method for building a histogram in robust line cutting. In Algorithm 6, the weighted sum of responses is not used, because the weight for each point is already set as pᵢ(1−pᵢ) (Line 6 in Algorithm 5). When computing leaf values, the second-order information may directly be obtained without performing the Newton-Raphson step in Algorithm 2.

FIG. 6 illustrates an exemplary application of efficient training of GAMs in accordance with some embodiments. This example application involves an automated online financial assistant that provides full lifecycle financial services for users. This assistant may be in a form of a chatbot, a mobile application, a webpage, another suitable form of a user interface, or any combination thereof. The following description uses a mobile application with a chatbot as an example. To further simplify the description, several assumptions are provided: there are two major entries 610 (a) and 610 (b) in the application that may trigger the dialogue flow 610 (c) of the chatbot for the application. The first entry 610 (a) is on a total asset page. The message in box 612 will notify the user when a financial product is close to maturity. In the second entry 610 (b), box 614 includes a clickable icon. Whenever the user clicks the box area in these two entries, he/she will be redirected to enter a dialogue flow, as shown in 610(c). A more complete interaction flow that the user may go through via the chatbot is shown in 620. “Overview” 616 in 610 (c) shows the details of the close-to-mature financial product. “Auto Renew” and “Not Now” in 610 (c) are the two choices for the user to select. If the user decided not to renew now, the platform would try to keep the user by asking whether he/she wants to find lower-risk products within the same category or try out other assets. Empirical transition probabilities are shown on the edges in 620. Since the user may drop (e.g., exit the application or cancel the interaction) at any stage, the outgoing edges may not necessarily sum to 1.

Without personalization, all users will start with “Overview,” which may be tedious for users with particular needs to go through the whole flow from the beginning. Therefore, an efficiently trained GAM may be handy to find global explanations to gain insights from the data (e.g., users of specific features tend to like one entry over another), so that the platform can provide different users with different entries in the dialogue.

In some embodiments, efficient GAM training may start with collecting historical data records. In this case, logs of users interacting with the platform may be collected for a period of time. A plurality of user features may be studied. In this example, the user features may include various features related to the user, the user's product, the user's historical behavior, market features, and other suitable features. Some example features include user portfolio features (e.g., number of mutual funds), page-level features (e.g., number of clicks on news pages in 3 days), region-level features (e.g., number of clicks on account positions in 15 days), gain/loss features (e.g., total gain or mutual funds in 7 days), user trading behavior features (e.g., number of trades in 30 days), market-level features (e.g., number of positive events in 7 days), promotional features (e.g., whether a coupon was redeemed), user profile features (e.g., education level).

In some embodiments, different GAMs may be trained for different scenarios that are interesting to the platform. Exemplary scenarios may include user choices between “renew” and “not now and drop,” “renew” and “not now,” “find lower-risk products” and “not now and drop,” and “try other assets” and “not now and drop.” For each of the scenarios, a plurality of users' interactions may be collected, which may include positive samples (e.g., interactions in which the first user choice was selected) and negative samples (e.g., interactions in which the second user choice was selected). For each of the scenarios, the above-described efficient GAM training method (subagging and LogitBoost) may be applied to find global explanations based on the historical data. For example, the construction of histograms may be accelerated by avoiding scanning overlapped historical data records between different training datasets or samples. In some embodiments, a single-feature machine learning model (also called a shallow tree, a weak leaner, or a shape function) may be trained for each user features to explain the relationship between the feature and the user responses in the scenario (e.g., the relationship between user's education level and his/her choice of purchasing specific financial products).

In some embodiments, various personalization strategies may be developed based on the global explanations provided by the efficiently trained GAM. For example, for users with high account balance, the dialogue may start directly with “Find Lower-Risk Products,” and Entry 1 610 (a) may display “Let us find lower-risk financial products for you.” As another example, for users who frequently visit information pages of different mutual funds, the dialogue may directly start with “Try Other Assets,” and accordingly Entry 1 610 (a) may display a message of “Do you want to find other assets?” As yet another example, for users who have few clicks on the account position page, the “Overview” state may be skipped and the users may be directly asked whether to renew the product. Accordingly, Entry 1 610 (a) may display “Do you want to renew your financial product?” This way, different users may receive personalized user interfaces with different messages (linking to different services) determined based on user features.

Besides the above-described use cases for providing personalized services (e.g., user interfaces), the method of efficient training of GAMs may be applied to other scenarios involving users interacting with a system. For example, in a risk-detection or risk-evaluation system, a user (including a user request, a user action, a user profile, etc.) may be associated with a plurality of features, and the system may train GAMs to learn the relationships between the plurality of features and risk levels and thus provide more accurate risk evaluation. As another example, riders and drivers in a ride-sharing or ride-hailing platform may be associated with various features, the platform may train GAMs to learn relationships between the various features and the rider/driver's preferences, and thus provide more accurate services (e.g., order dispatching, route recommendation, incentives, etc.)

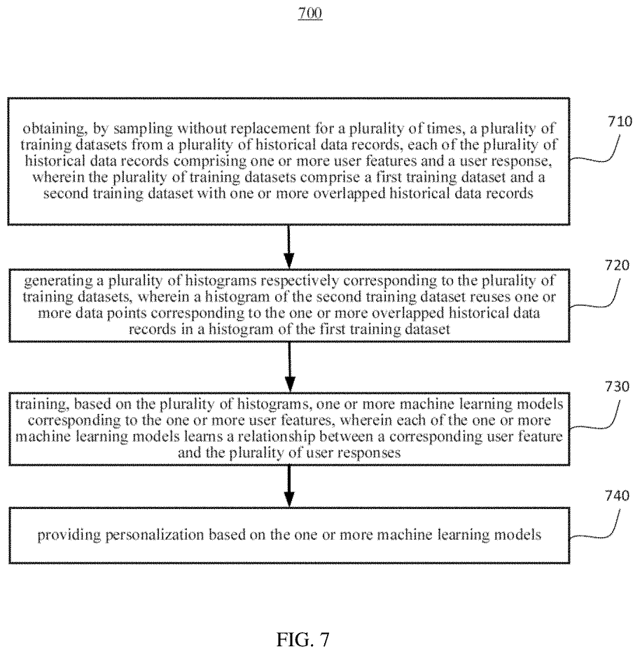

FIG. 7 illustrates an exemplary method 700 for determining routing in accordance with some embodiments. The method 700 may be implemented by the computing system 120 shown in FIG. 1, and correspond to embodiments illustrated in FIGS. 1-6. Depending on the implementation, the method may have additional, fewer, or alternative steps.

Block 710 includes obtaining, by sampling without replacement for a plurality of times, a plurality of training datasets from a plurality of historical data records, each of the plurality of historical data records comprising one or more user features and a user response, where the plurality of training datasets include a first training dataset and a second training dataset with one or more overlapped historical data records. In some embodiments, obtaining the plurality of training datasets from the plurality of historical data records by sampling without replacement for a plurality of times includes: randomly arranging the plurality of historical data records; sampling the first training dataset without replacement from the plurality of randomly arranged historical data records; randomly rearranging the plurality of historical data records; and sampling the second training dataset without replacement from the plurality of randomly rearranged historical data records. In some embodiments, the first training dataset and the second training dataset are equal in size and each includes more than half of the plurality of historical data records.

Block 720 includes generating a plurality of histograms respectively corresponding to the plurality of training datasets, where a histogram of the second training dataset reuses one or more data points corresponding to the one or more overlapped historical data records in a histogram of the first training dataset. In some embodiments, the generating a plurality of histograms respectively corresponding to the plurality of training datasets includes: generating a first histogram based on the first training dataset; identifying one or more first historical data records that are in the first training dataset but not in the second training dataset, and one or more second historical data records that are in the second training dataset but not in the first training dataset; and generating a second histogram based on the first histogram by removing one or more data points corresponding to the one or more first historical data records and adding one or more data points corresponding to the one or more second historical data records.

Block 730 includes training, based on the plurality of histograms, one or more machine learning models corresponding to the one or more user features, where each of the one or more machine learning models learns a relationship between a corresponding user feature and the plurality of user responses. In some embodiments, the training one or more machine learning models corresponding to one or more user features based on the plurality of histograms includes: for each of the one or more user features, constructing a plurality of single-feature shallow trees based on the plurality of histograms; and aggregating the plurality of single-feature shallow trees into a single-feature machine learning model corresponding to the user feature. In some embodiments, the one or more machine learning models include one or more regression models or one or more classification models.

Block 740 includes providing personalization based on the one or more machine learning models. In some embodiments, the personalization includes personalized product or service configurations, individual-level predictions based on the one or more features of an individual, or other suitable personalization.

In some embodiments, the method 700 may further include ensembling the one or more machine learning models into a generalized linear model for predicting user responses based on the one or more user features; and where the providing personalization based on the one or more machine learning models includes: providing personalization based on the generalized linear model.

In some embodiments, the method 700 may further include ordering the plurality of training datasets for minimizing a computational cost for generating the plurality of histograms by the following steps: constructing a fully connected graph comprising a plurality of nodes corresponding to the plurality of training datasets and a plurality of edges, where each of the plurality of edges connects two training datasets and is associated with a weight related to a number of historical data records belonging to either of the two training datasets, but not in their intersection; determining a minimum spanning tree of the fully connected graph, where the minimum spanning tree includes a subset of the plurality of edges connecting the plurality of nodes with a minimum total edge weight; and ordering the plurality of training datasets based on the minimum spanning tree. In some embodiments, the ordering the plurality of training datasets based on the minimum spanning tree includes: selecting a node from the minimum spanning tree as a starting point; performing a breadth-first search (BFS) to determine a processing sequence of the plurality of nodes in the minimum spanning tree; and ordering the plurality of training datasets based on the processing sequence of the plurality of nodes in the minimum spanning tree.

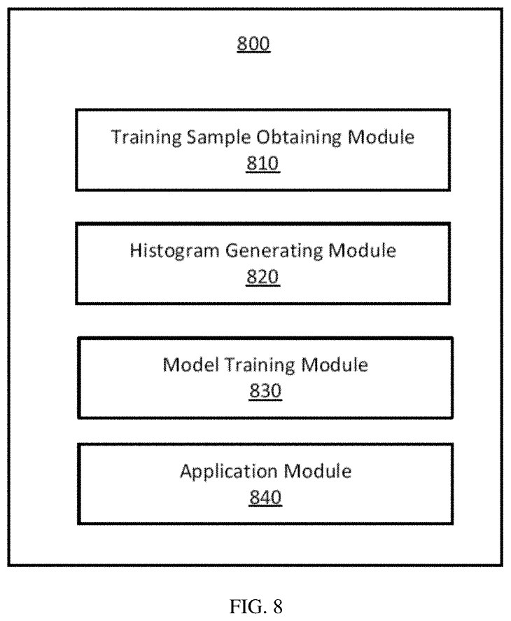

FIG. 8 illustrates a block diagram of a computer system 800 for training and applying explainable machine learning models in accordance with some embodiments. The components of the computer system 800 presented below are intended to be illustrative. Depending on the implementation, the computer system 800 may include additional, fewer, or alternative components.

The computer system may be an exemplary implementation of the system, operations, methods shown in FIGS. 1-7. The computer system 800 may include one or more processors and one or more non-transitory computer-readable storage media (e.g., one or more memories) coupled to the one or more processors and configured with instructions executable by the one or more processors to cause the system or device (e.g., the processor) to perform the above-described methods, e.g., the method 700. The computer system 800 may include various units/modules corresponding to the instructions (e.g., software instructions).

In some embodiments, the computer system 800 may be referred to as an apparatus for training and applying explainable machine learning models such as GAMs. The apparatus may include a training sample obtaining module 810, a histogram generating module 820, a model training module 830, and an application module 840. In some embodiments, the training sample obtaining module 810 may obtain, by sampling without replacement for a plurality of times, a plurality of training datasets from a plurality of historical data records, each of the plurality of historical data records comprising one or more user features and a user response, where the plurality of training datasets include a first training dataset and a second training dataset with one or more overlapped historical data records. In some embodiments, the histogram generating module 820 may generate a plurality of histograms respectively corresponding to the plurality of training datasets, where a histogram of the second training dataset reuses one or more data points corresponding to the one or more overlapped historical data records in a histogram of the first training dataset. In some embodiments, the model training module 830 may train based on the plurality of histograms, one or more machine learning models corresponding to the one or more user features, where each of the one or more machine learning models learns a relationship between a corresponding user feature and the plurality of user responses. In some embodiments, the application module 840 may provide personalization (such as goods, services, predictions) based on the one or more machine learning models.

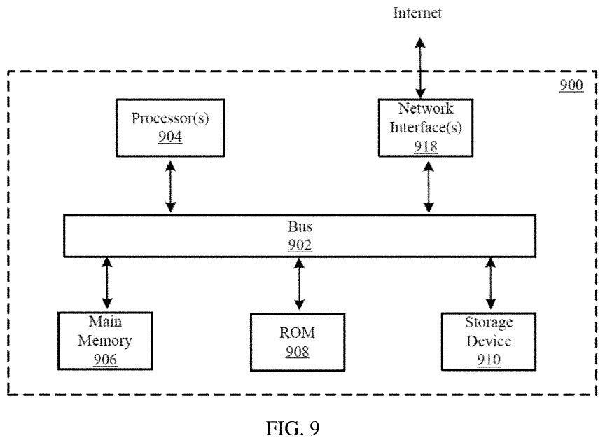

FIG. 9 illustrates a block diagram of a computer system 900 in which any of the embodiments described herein may be implemented. The computer system 900 may be implemented in any of the components of the environments, systems, or methods illustrated in FIGS. 1-8. One or more of the example methods illustrated by FIGS. 1-8 may be performed by one or more implementations of the computer system 900.

The computer system 900 may include a bus 902 or other communication mechanism for communicating information, one or more hardware processor(s) 904 coupled with bus 902 for processing information. Hardware processor(s) 904 may be, for example, one or more general purpose microprocessors.

The computer system 900 may also include a main memory 906, such as a random-access memory (RAM), cache and/or other dynamic storage devices, coupled to bus 902 for storing information and instructions executable by processor(s) 904. Main memory 906 also may be used for storing temporary variables or other intermediate information during execution of instructions executable by processor(s) 904. Such instructions, when stored in storage media accessible to processor(s) 904, render computer system 900 into a special-purpose machine that is customized to perform the operations specified in the instructions. The computer system 900 may further include a read only memory (ROM) 908 or other static storage device coupled to bus 902 for storing static information and instructions for processor(s) 904. A storage device 910, such as a magnetic disk, optical disk, or USB thumb drive (Flash drive), etc., may be provided and coupled to bus 902 for storing information and instructions.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the operations, methods, and processes described herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 may cause processor(s) 904 to perform the process steps described herein. In alternative embodiments, hard-wired circuitry may be used in place of or in combination with software instructions.

The main memory 906, the ROM 908, and/or the storage device 910 may include non-transitory storage media. The term “non-transitory media,” and similar terms, as used herein refers to media that store data and/or instructions that cause a machine to operate in a specific fashion, the media excludes transitory signals. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 900 may include a network interface 918 coupled to bus 902. Network interface 918 may provide a two-way data communication coupling to one or more network links that are connected to one or more local networks. For example, network interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicate with a WAN). Wireless links may also be implemented. In any such implementation, network interface 918 may send and receive electrical, electromagnetic or optical signals that carry digital data streams representing various types of information.

The computer system 900 can send messages and receive data, including program code, through the network(s), network link and network interface 918. In the Internet example, a server might transmit a requested code for an application program through the Internet, the ISP, the local network and the network interface 918.

The received code may be executed by processor(s) 904 as it is received, and/or stored in storage device 910, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another or may be combined in various ways. All possible combinations and sub-combinations are intended to fall within the scope of this specification. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The examples of blocks or states may be performed in serial, in parallel, or in some other manner. Blocks or states may be added to or removed from the disclosed embodiments. The examples of systems and components described herein may be configured differently than described. For example, elements may be added to, removed from, or rearranged compared to the disclosed embodiments.

The various operations of methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some embodiments, the processors or processor-implemented engines may be located in a single geographic location (e.g., within a home environment, an office environment, or a server farm). In other embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific embodiments, various modifications and changes may be made to these embodiments without departing from the broader scope of embodiments of the specification. The Detailed Description should not to be taken in a limiting sense, and the scope of various embodiments is defined only by the appended claims, along with the full range of equivalents to which such claims are entitled. Furthermore, related terms (such as “first,” “second,” “third,” etc.) used herein do not denote any order, height, or importance, but rather are used to distinguish one element from another element. Furthermore, the terms “a,” “an,” and “plurality” do not denote a limitation of quantity herein, but rather denote the presence of at least one of the articles mentioned.

1. A computer-implemented method, comprising:
obtaining, by sampling without replacement for a plurality of times, a plurality of training datasets from a plurality of historical data records, each of the plurality of historical data records comprising one or more user features and a user response, wherein the plurality of training datasets comprise a first training dataset and a second training dataset with one or more overlapped historical data records;
generating a plurality of histograms respectively corresponding to the plurality of training datasets, wherein a histogram of the second training dataset reuses one or more data points corresponding to the one or more overlapped historical data records in a histogram of the first training dataset;
training, based on the plurality of histograms, one or more machine learning models corresponding to the one or more user features, wherein each of the one or more machine learning models learns a relationship between a corresponding user feature and the plurality of user responses; and
providing personalization based on the one or more machine learning models.

2. The method of claim 1, further comprising:
ensembling the one or more machine learning models into a generalized linear model for predicting user responses based on the one or more user features; and
wherein the providing personalization based on the one or more machine learning models comprises:
providing personalization based on the generalized linear model.

3. The method of claim 1, wherein obtaining the plurality of training datasets from the plurality of historical data records by sampling without replacement for a plurality of times comprises:
randomly arranging the plurality of historical data records;
sampling the first training dataset without replacement from the plurality of randomly arranged historical data records;
randomly rearranging the plurality of historical data records; and
sampling the second training dataset without replacement from the plurality of randomly rearranged historical data records.

4. The method of claim 3, wherein the first training dataset and the second training dataset are equal in size and each comprises more than half of the plurality of historical data records.

5. The method of claim 1, wherein the generating a plurality of histograms respectively corresponding to the plurality of training datasets comprises:
generating a first histogram based on the first training dataset;
identifying one or more first historical data records that are in the first training dataset but not in the second training dataset, and one or more second historical data records that are in the second training dataset but not in the first training dataset; and
generating a second histogram based on the first histogram by removing one or more data points corresponding to the one or more first historical data records and adding one or more data points corresponding to the one or more second historical data records.

6. The method of claim 1, wherein the training one or more machine learning models corresponding to one or more user features based on the plurality of histograms comprises:
for each of the one or more user features, constructing a plurality of single-feature shallow trees based on the plurality of histograms; and
aggregating the plurality of single-feature shallow trees into a single-feature machine learning model corresponding to the user feature.

7. The method of claim 1, wherein the one or more machine learning models comprise one or more regression models or one or more classification models.

8. The method of claim 1, further comprising:
ordering the plurality of training datasets for minimizing a computational cost for generating the plurality of histograms.

9. The method of claim 8, wherein the ordering the plurality of training datasets comprises:
constructing a fully connected graph comprising a plurality of nodes corresponding to the plurality of training datasets and a plurality of edges, wherein each of the plurality of edges connects two training datasets and is associated with a weight related to a number of historical data records belonging to either of the two training datasets, but not in their intersection;
determining a minimum spanning tree of the fully connected graph, wherein the minimum spanning tree comprises a subset of the plurality of edges connecting the plurality of nodes with a minimum total edge weight; and
ordering the plurality of training datasets based on the minimum spanning tree.

10. The method of claim 9, wherein the ordering the plurality of training datasets based on the minimum spanning tree comprises:
selecting a node from the minimum spanning tree as a starting point;
performing a breadth-first search (BFS) to determine a processing sequence of the plurality of nodes in the minimum spanning tree; and
ordering the plurality of training datasets based on the processing sequence of the plurality of nodes in the minimum spanning tree.

11. The method of claim 1, wherein the personalization comprises personalized product or service configurations.

12. The method of claim 1, wherein the personalization comprises individual-level predictions based on the one or more features of an individual.

13. A system comprising one or more processors and one or more non-transitory computer-readable memories coupled to the one or more processors and configured with instructions executable by the one or more processors to cause the system to perform operations comprising:
obtaining, by sampling without replacement for a plurality of times, a plurality of training datasets from a plurality of historical data records, each of the plurality of historical data records comprising one or more user features and a user response, wherein the plurality of training datasets comprise a first training dataset and a second training dataset with one or more overlapped historical data records;
generating a plurality of histograms respectively corresponding to the plurality of training datasets, wherein a histogram of the second training dataset reuses one or more data points corresponding to the one or more overlapped historical data records in a histogram of the first training dataset;
training, based on the plurality of histograms, one or more machine learning models corresponding to the one or more user features, wherein each of the one or more machine learning models learns a relationship between a corresponding user feature and the plurality of user responses; and
providing personalization based on the one or more machine learning models.

14. The system of claim 13, wherein the operations further comprise:
ensembling the one or more machine learning models into a generalized linear model for predicting user responses based on the one or more user features; and
wherein the providing personalization based on the one or more machine learning models comprises:
providing personalization based on the generalized linear model.

15. The system of claim 13, wherein the generating a plurality of histograms respectively corresponding to the plurality of training datasets comprises:
generating a first histogram based on the first training dataset;
identifying one or more first historical data records that are in the first training dataset but not in the second training dataset, and one or more second historical data records that are in the second training dataset but not in the first training dataset; and
generating a second histogram based on the first histogram by removing one or more data points corresponding to the one or more first historical data records and adding one or more data points corresponding to the one or more second historical data records.

16. The system of claim 13, wherein the operations further comprise ordering the plurality of training datasets for minimizing a computational cost for generating the plurality of histograms by:
constructing a fully connected graph comprising a plurality of nodes corresponding to the plurality of training datasets and a plurality of edges, wherein each of the plurality of edges connects two training datasets and is associated with a weight related to a number of historical data records belonging to either of the two training datasets, but not in their intersection;
determining a minimum spanning tree of the fully connected graph, wherein the minimum spanning tree comprises a subset of the plurality of edges connecting the plurality of nodes with a minimum total edge weight; and
ordering the plurality of training datasets based on the minimum spanning tree.

17. A non-transitory computer-readable storage medium configured with instructions executable by one or more processors to cause the one or more processors to perform operations comprising:
obtaining, by sampling without replacement for a plurality of times, a plurality of training datasets from a plurality of historical data records, each of the plurality of historical data records comprising one or more user features and a user response, wherein the plurality of training datasets comprise a first training dataset and a second training dataset with one or more overlapped historical data records;
generating a plurality of histograms respectively corresponding to the plurality of training datasets, wherein a histogram of the second training dataset reuses one or more data points corresponding to the one or more overlapped historical data records in a histogram of the first training dataset;
training, based on the plurality of histograms, one or more machine learning models corresponding to the one or more user features, wherein each of the one or more machine learning models learns a relationship between a corresponding user feature and the plurality of user responses; and
providing personalization based on the one or more machine learning models.

18. The non-transitory computer-readable storage medium of claim 17, wherein the generating a plurality of histograms respectively corresponding to the plurality of training datasets comprises:
generating a first histogram based on the first training dataset;
identifying one or more first historical data records that are in the first training dataset but not in the second training dataset, and one or more second historical data records that are in the second training dataset but not in the first training dataset; and
generating a second histogram based on the first histogram by removing one or more data points corresponding to the one or more first historical data records and adding one or more data points corresponding to the one or more second historical data records.

19. The non-transitory computer-readable storage medium of claim 17, wherein the operations further comprise ordering the plurality of training datasets for minimizing a computational cost for generating the plurality of histograms by:
constructing a fully connected graph comprising a plurality of nodes corresponding to the plurality of training datasets and a plurality of edges, wherein each of the plurality of edges connects two training datasets and is associated with a weight related to a number of historical data records belonging to either of the two training datasets, but not in their intersection;
determining a minimum spanning tree of the fully connected graph, wherein the minimum spanning tree comprises a subset of the plurality of edges connecting the plurality of nodes with a minimum total edge weight; and
ordering the plurality of training datasets based on the minimum spanning tree.

20. The non-transitory computer-readable storage medium of claim 17, wherein the operations further comprise:
ensembling the one or more machine learning models into a generalized linear model for predicting user responses based on the one or more user features; and
wherein the providing personalization based on the one or more machine learning models comprises:
providing personalization based on the generalized linear model.
